(19) United States
(12) Patent Application Publication
(10) Pub. No.: US 2003/0184486 A1
(43) Pub. Date: Oct. 2, 2003

(54) Waveguide back-fire reflector antenna feed

(76) Inventors: Lotfollah Shafai, Winnipeg (CA); Ahmed Abdelwahed Kishk, Oxford, MS (US); Mohamed A. Barakat, Winnipeg (CA)

Correspondence Address: DARBY & DARBY P.C., 805 Third Avenue, New York, NY, 10022-7513, US

(21) Appl. No.: 10/112,670

(22) Filed: Mar. 29, 2002

(51) Int. Cl. H01Q 13/00

(52) U.S. Cl. 343/779; 343/785

(57) ABSTRACT

A compact high efficiency waveguide feed for reflector antennas includes a dielectric loaded aperture at its end for radiating energy to the reflector. The feed comprises a circular waveguide that carries the dominant TE11 mode, and terminates in a dielectric rod with an end cap. The exposed length of the dielectric rod between the end cap and the waveguide end constitutes a cylindrical aperture that radiates towards the reflector. The end cap and dielectric aperture dimensions are optimized for reflector high efficiency. Its small diameter provides an extremely compact feed, which reduces the sidelobes and operates well with both deep and shallow reflectors. As a result, high efficiency and low sidelobe performance can be obtained with symmetric centre fed reflectors.

### DESCRIPTION

1Technical Field

This invention relates to reflector antennas.

2Background Art

In general, reflector antennas have a feed element at the focus of a parabolic main reflecting surface. Usually, they are used for high gain operations and are large in size. It is desirable, therefore, to improve their design to reduce size and cost. Typically, reflector antenna configurations include symmetric and offset configurations. Symmetric reflectors offer better electrical and mechanical performance, but have struts supporting the feed element at the focus, causing blockage and a consequent deterioration in performance. Offset configurations are less susceptible to blockage problems, but are difficult to fabricate and align.

Considerable research has been devoted to developing configurations which provide improved performance. Thus, one technique is based upon dual reflector configurations, i.e. having a parabolic main reflector, a sub-reflector or “splash plate”, and a waveguide. In transmission mode, radiation from the waveguide is reflected by the sub-reflector as a spherical wave onto the main reflector, which reflects it as a plane wave. In reception mode, the converse applies. Positioning the subreflector closer to the feed element allows its size to be reduced and enables it to be supported by a radome held on the feed element. Such designs may be further improved by shaping the subreflector to “illuminate” the reflector more efficiently, for example by reducing side lobes. It is desirable to reduce side lobes, both to avoid interference and to improve efficiency.

For high reflector gain and efficiency, the feed must behave like a point source located at its focal point. This will ensure the phase uniformity of the reflector aperture field, which is essential for high efficiency. However, the uniformity of the field amplitude of the reflector aperture raises the side lobes, which is undesirable for most applications. In practice, therefore, the reflector feed is designed to provide a uniform phase distribution, but a degree of amplitude taper to lower the side lobe levels.

It is known to reduce side lobes by providing a shroud around the edge of the main reflector to prevent wide-angle emissions and improve phase distribution by shaping the subreflector. Thus, U.S. Pat. No. 6,107,973, (Charles M. Knop et al., August 2000) describes a compact shaped subreflector supported by a radome placed on its feed element. The feed element is a simple dual mode horn, and high reflector efficiency is achieved by shaping the subreflector. U.S. Pat. No. 5,959,590 (John R. Sanford et al., September 1999) describes an antenna having a subreflector which is corrugated and shaped so as to improve the main reflector illumination and to reduce the sidelobes.

In such antennas, the spherical wave is diffracted by the subreflector when being reflected to illuminate the main reflector. This diffraction phenomenon limits the amount by which the size of the subreflector can be reduced without the corresponding reduction in reflection efficiency reaching unacceptable levels.

It is known that, for efficient subreflector operation, the diameter of the subreflector preferably is about ten wavelengths. It starts failing to function when its diameter falls below three wavelengths. Reducing the distance between the subreflector and the feed element, as is the case in the antennas disclosed by Knop et al. and by Sanford et al., causes a deterioration in the phase uniformity of the reflector illumination that is partially corrected by shaping, specifically corrugating, the subreflector. Hence, such antennas do not overcome the problem entirely and the subreflector still is large with respect to the wavelength.

### SUMMARY OF THE INVENTION

According to the present invention, a reflector antenna comprises a main reflector and a feed unit for directing feed radiation towards the main reflector or receiving received radiation from the main reflector, wherein the feed unit comprises a loaded aperture for directing radiation from a waveguide to the main reflector or for directing radiation received from the main reflector to the waveguide.

The aperture may be formed between the open end of the feed waveguide and an end cap spaced therefrom.

The aperture may be provided by a short dielectric rod having a first, narrower portion inserted into an end of the waveguide and a second, slightly larger portion protruding from the waveguide and having said end cap on a distal end thereof.

With such an arrangement, the feed aperture illumination is due to the guided wave of the waveguide and its radiation towards the main reflector is controlled by the aperture dimensions and not the size of the end cap.

In embodiments of the present invention, the diameter of the aperture preferably is kept small so that it behaves like a point source. The amplitude of the radiated field is controlled by the axial length of the aperture and the shape of the end cap. They are optimized so as to provide for efficient illumination of the reflector to increase its gain and at the same time keep the sidelobes of the reflector pattern lower, as compared with conventional dual reflector antennas.

### DESCRIPTION OF THE DRAWINGS

An embodiment of the invention will now be described by way of example only and with reference to the accompanying drawings, in which:

FIG. 1, labelled “PRIOR ART”, shows the configuration of a conventional dual-reflector antenna system, with a central waveguide feed and subreflector;

FIG. 2 shows the configuration of a reflector antenna embodying the present invention; and

FIG. 3 is a detail cross-sectional view of a feed element of the reflector antenna of FIG. 2.

### DETAILED DESCRIPTION OF A PREFERRED EMBODIMENT

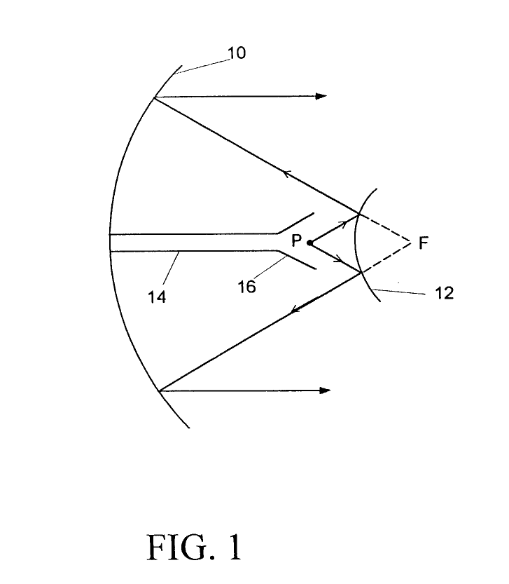

FIG. 1 shows a conventional dual reflector antenna according to the prior art, comprising a main reflector 10, having a parabolic surface, and a subreflector 12 having a hyperbolic surface. A circular waveguide 14 and a horn antenna 16, connected together, constitute the reflector feed unit that illuminates the subreflector 12. The subreflector diffraction field, in turn, illuminates the main reflector that re-radiates a high gain beam R. The radiation of horn antenna 16 appears to be originating from a point P, known as its phase centre, and that of the main reflector 10 appears to be originating from its focal point F. Thus, for proper focussing of the antenna system, the two focal points of the subreflector must coincide with points P and F. From an electromagnetic point of view, the spherical waves originating from the horn phase centre P must see a large subreflector, with respect to the wavelength, in order to be reflected substantially towards the main reflector. Nevertheless, some wave energy spills over beyond the edge of subreflector 12 or is diffracted away from the main reflector 10, reducing its efficiency.

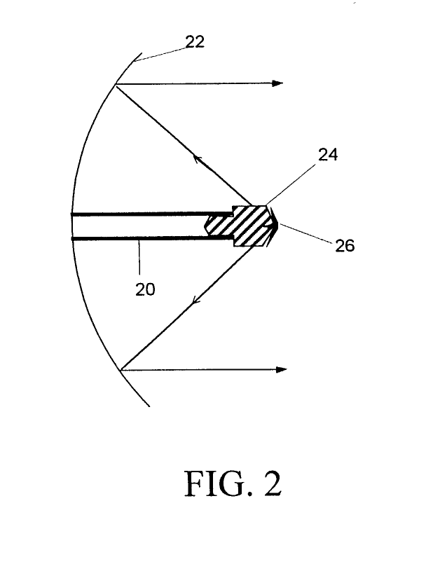

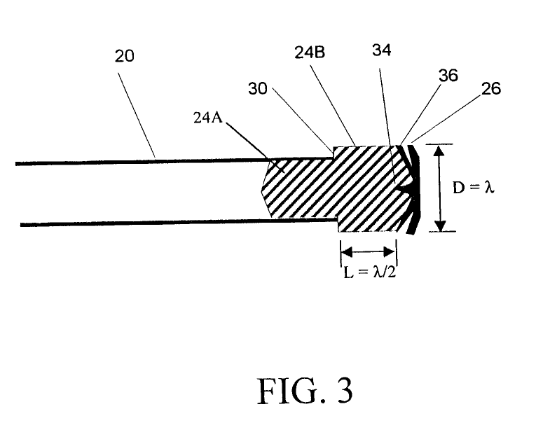

An antenna embodying the present invention will now be described with reference to FIGS. 2 and 3. As shown in FIG. 2, the feed unit comprises a circular waveguide 20 which carries the dominant TE11 mode and radiates backwards to illuminate the main reflector 22. As shown in more detail in FIG. 3, the waveguide 20 terminates in a dielectric rod 24 capped by a conducting end cap 26. The dielectric rod 24 has a spigot portion 24A extending into the distal end of the waveguide 20 and an interference fit therein and a larger diameter distal portion 24B protruding beyond the end of the waveguide 20. A shoulder 30 between the spigot portion 24A and the distal portion 24B abuts the end of the waveguide 20.

The length L of the distal portion 24B between the end of waveguide 20 and the end cap 26, the surface of which forms the radiating aperture of the feed unit, is about one half wavelength at the operating frequency. The diameter of this aperture is slightly larger than the outside diameter of the waveguide 20 so as to reduce the effect of the waveguide 20 on the aperture radiation towards the main reflector 22 (FIG. 2). In this embodiment of the invention, the aperture diameter is about one wavelength at the operating frequency. The section of the waveguide 20 which is occupied by the dielectric spigot portion 24A has an effective diameter about 40 percent less due to dielectric loading. The effective diameter of the remainder of the waveguide 20 is larger, i.e., only about 20 percent less than the diameter of the aperture.

As shown more clearly in FIG. 3, the end cap 26 comprises a central, generally conical pin 34, which reflects radiation from the waveguide 20 outwards and around the end of the waveguide so as to help to reduce the energy reflected back into the waveguide 20 and influence the field distribution on the aperture. The end cap 26 also has a quarter wavelength choke 36, to reduce the energy leakage behind the end cap 26. To ensure the phase uniformity of the reflector illumination, the diameter of the radiating aperture 24B must be kept small, and in the present embodiment it is about one wavelength. In practice, the radiating aperture dimension will depend on the focal length and diameter of reflector 22 and may be re-optimized. This re-optimization can be done by an electromagnetic analysis described in the above mentioned manuscript on “Microwave Horns and Feeds” and the corresponding software developed by A. A. Kishk. The spigot portion 24A of the dielectric rod inserted into waveguide 20 is not critical to the reflector illumination and can be modified for impedance matching of the waveguide 20.

A tight relationship exists between the various parameters, especially the end cap and dielectric aperture dimensions, i.e., aperture length and diameter, and the waveguide diameter, which may be optimized using such electromagnetic analysis for reflector high efficiency. Their small diameter provides for an extremely compact feed, which reduces the sidelobes and operates well with both deep and shallow reflectors. As a result, high efficiency and low sidelobe performance can be obtained with symmetric centre fed reflectors.

### INDUSTRIAL APPLICABILITY

Embodiments of the invention advantageously provide a compact reflector antenna having high efficiency illumination of the reflector with a feed unit that is extremely small, thus ensuring small blockage and low sidelobes.

1. A reflector antenna comprising a main reflector and a feed unit for directing feed radiation towards the main reflector or receiving received radiation from the main reflector, wherein the feed unit comprises a loaded aperture disposed for directing radiation from a waveguide to the main reflector in transmission mode or for directing radiation received from the main reflector to the waveguide in reception mode.

2. A reflector antenna according to claim 1, wherein the aperture is formed between an end of the waveguide and an end cap spaced therefrom.

3. A reflector antenna according to claim 2, wherein the aperture is provided by a short dielectric rod having a first, narrower portion inserted into said end of the waveguide and a second, larger portion protruding from the waveguide and having said end cap on a distal end thereof.

4. A reflector antenna according to claim 1, wherein the end cap has a central deflector for reflecting radiation received from the waveguide outwards to pass around the adjacent end of the waveguide and towards the reflector.

5. A reflector antenna according to claim 1, wherein the aperture is provided by a short dielectric rod having a first, narrower portion inserted into said end of the waveguide and a second, larger portion protruding from the waveguide and having said end cap on a distal end thereof and wherein the end cap has a central deflector for reflecting radiation received from the waveguide outwards to pass around the adjacent end of the waveguide and towards the reflector.

6. A reflector antenna according to claim 1, wherein the aperture is formed between an end of the waveguide and an end cap spaced therefrom and wherein the aperture is provided by a short dielectric rod having a first, narrower portion inserted into said end of the waveguide and a second, larger portion protruding from the waveguide and having said end cap on a distal end thereof and, wherein the end cap has a central deflector for reflecting radiation received from the waveguide outwards to pass around the adjacent end of the waveguide and towards the reflector.

7. A reflector antenna according to claim 5, wherein the deflector comprises a conical pin protruding towards said waveguide.

8. A reflector antenna according to claim 6, wherein the deflector comprises a conical pin protruding towards said waveguide.

9. A reflector antenna according to claim 1, wherein the end cap further comprises a quarter wavelength choke for reducing back radiation.

10. An antenna system according to claim 1, wherein the diameter of the loaded aperture is substantially larger than the waveguide diameter.

11. An antenna system as a feed for reflector antennas comprising a waveguide attached axially to the reflector at one end and terminated in a dielectric rod plug, having a conductive end cap at the other, leaving exposed a section of the dielectric rod, as a cylindrical aperture, between the waveguide and endcap to radiate.
